(19) United States
(12) Patent Application Publication
(10) Pub. No.: US 2015/0114227 A1
(43) Pub. Date: Apr. 30, 2015

(54) GAS/LIQUID SEPARATOR

(71) Applicant: Norgren Limited, Staffordshire (GB)

(72) Inventors: Jonathan Brooks, Staffordshire (GB); Richard Edwards, Staffordshire (GB); Simon Gass, Staffordshire (GB)

(73) Assignee: Norgren Limited, Staffordshire (GB)

(21) Appl. No.: 14/399,030

(22) PCT Filed: May 9, 2013
(86) PCT No.: PCT/GB2013/051200

§ 371 Date: Nov. 5, 2014

(30) Foreign Application Priority Data
May 10, 2012 (GB) 1208169.1

(51) Int. Cl. B01D 19/00

(52) U.S. Cl. CPC B01D 19/0057; B01D 19/0042
USPC 95/261; 96/155; 96/208; 95/241; 95/260

(57) ABSTRACT

A gas/liquid separator (120) is provided. The gas/liquid separator (120) includes a separator shell (121) forming an internal chamber (125), a neck (128) formed in an end of the separator shell (121), a separator tube (126) extending into the separator shell (121), with a proximal end (131) forming an output port (123) and with a distal end (132) extending into the internal chamber (125), and an input port (122) formed between the separator tube (126) and the neck (128). The distal end (132) of the separator tube (126) is located in a central interior region of the separator shell (121) wherein liquid phase material accumulates in the internal chamber (125) and is not drawn out of the gas/liquid separator (120) by the separator tube (126).

### BACKGROUND OF THE INVENTION

1. Field of the Invention

The invention is related to the field of separators, and more particularly, to a gas/liquid separator.

2. Description of the Prior Art

Pressurized gas may be used in many applications. Pressurized gas may be used to provide pneumatic power, to provide pneumatic pressure, or to entrain and transport other materials. For example, pressurized gas may be used to pick up, entrain, and transport a powder in some applications.

In the prior art, carbon dioxide gas may be used to pick up, entrain, and transport a powder. Carbon dioxide gas is used because it is naturally existent and is not problematic if released into the environment. Carbon dioxide gas is inexpensive, plentiful, non-toxic, easy to handle, and tends to be non-reactive in most applications.

Carbon dioxide gas is usually provided in a pressurized container. However, when released from a pressurized container, a carbon dioxide material may include some liquid phase carbon dioxide. Release of highly pressurized gas results in rapid cooling of the gas and may result in condensation into some liquid phase material. Further, if the container is capable of holding high pressures, the carbon dioxide gas may be outputted as a liquid phase of the carbon dioxide.

When used in a powder delivery system, the liquid phase carbon dioxide is problematic and can cause a powder to clump together and/or cling to internal surfaces.

### ASPECTS OF THE INVENTION

In some aspects of the invention, a gas/liquid separator comprises:
a separator shell forming an internal chamber;
a neck formed in an end of the separator shell;
a separator tube extending into the separator shell, with a proximal end forming an output port and with a distal end extending into the internal chamber; and
an input port formed between the separator tube and the neck, wherein the distal end of the separator tube is located in a central interior region of the separator shell and wherein liquid phase material accumulates in the internal chamber and is not drawn out of the gas/liquid separator by the separator tube.

Preferably, the input port comprises a clearance between the separator tube and the neck of the separator shell.

Preferably, the input port creates a substantially turbulent flow into the gas/liquid separator.

Preferably, the input port creates a substantially rotating, centrifugal flow into the gas/liquid separator.

Preferably, the proximal end of the separator tube extends out from the separator shell to form the output port.

Preferably, the proximal end of the separator tube ends substantially at an end of the separator shell to form the output port.

Preferably, the gas/liquid separator is a component of a gas delivery system, with the gas delivery system comprising a gas supply container, a manifold coupled to the gas supply container, and the gas/liquid separator coupled to the manifold, wherein the gas/liquid separator receives a gas material from the gas supply container, separates the gas material into a gas phase material, and draws out the gas phase material, wherein the liquid phase material is retained in the gas/liquid separator.

Preferably, further comprising a gas controller coupled to the gas/liquid separator, wherein the gas controller is configured to regulate dispensation of gas phase material from the gas/liquid separator.

Preferably, further comprising a gas controller coupled between the gas supply container and the gas/liquid separator, wherein the gas controller is configured to regulate dispensation of gas phase material from the gas/liquid separator.

In some aspects of the invention, a method of forming a gas/liquid separator comprises:
providing a separator shell forming an internal chamber;
providing a neck formed in an end of the separator shell;
providing a separator tube extending into the separator shell, with a proximal end forming an output port and with a distal end extending into the internal chamber; and
providing an input port formed between the separator tube and the neck, wherein the distal end of the separator tube is located in a central interior region of the separator shell and wherein liquid phase material accumulates in the internal chamber and is not drawn out of the gas/liquid separator by the separator tube.

Preferably, the input port comprises a clearance between the separator tube and the neck of the separator shell.

Preferably, the input port creates a substantially turbulent flow into the gas/liquid separator.

Preferably, the input port creates a substantially rotating, centrifugal flow into the gas/liquid separator.

Preferably, the proximal end of the separator tube extends out from the separator shell to form the output port.

Preferably, the proximal end of the separator tube ends substantially at an end of the separator shell to form the output port.

Preferably, the gas/liquid separator is a component of a gas delivery system, with the gas delivery system comprising a gas supply container, a manifold coupled to the gas supply container, and the gas/liquid separator coupled to the manifold, wherein the gas/liquid separator receives a gas material from the gas supply container, separates the gas material into a gas phase material, and draws out the gas phase material, wherein the liquid phase material is retained in the gas/liquid separator.

Preferably, further comprising a gas controller coupled to the gas/liquid separator, wherein the gas controller is configured to regulate dispensation of gas phase material from the gas/liquid separator.

Preferably, further comprising a gas controller coupled between the gas supply container and the gas/liquid separator, wherein the gas controller is configured to regulate dispensation of gas phase material from the gas/liquid separator.

### BRIEF DESCRIPTION OF THE DRAWINGS

The same reference number represents the same element on all drawings. It should be understood that the drawings are not necessarily to scale.

FIG. 1 shows a gas delivery system according to an embodiment of the invention.

FIG. 2 shows the gas delivery system according to another embodiment of the invention.

FIG. 3 shows a gas delivery system configured to entrain and transport a powder according to an embodiment of the invention.

### DETAILED DESCRIPTION OF THE INVENTION

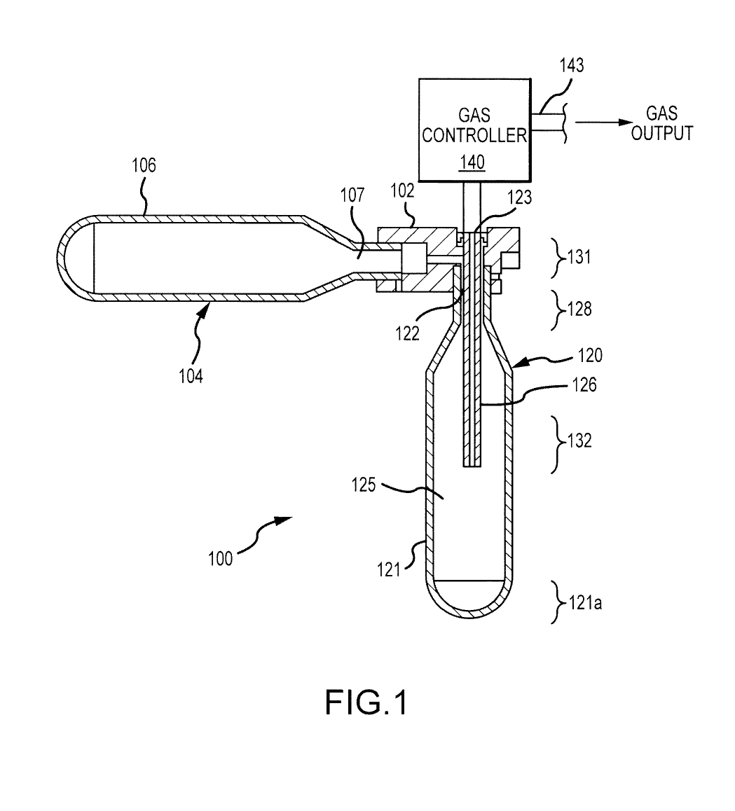

FIGS. 1-3 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 shows a gas delivery system 100 according to an embodiment of the invention. The gas delivery system 100 may provide gas at a predetermined flow rate and at a predetermined pressure. The gas delivery system 100 may provide a gas material wherein no liquid or liquid phase material is discharged by the gas delivery system 100. The gas delivery system 100 may be used to deliver gas to a variety of applications. The gas delivery system 100 may provide gas to entrain and move another material, including a powder material. Alternatively, the gas delivery system 100 may provide gas for pneumatic power, to provide pressurization, or for any other manner of use.

The gas delivery system 100 includes a manifold 102, a gas supply container 104, a gas/liquid separator 120, and a gas controller 140. The gas supply container 104, the gas/liquid separator 120, and the gas controller 140 are coupled to the manifold 102.

The manifold 102 comprises a body including one or more internal passages that couple together the gas supply container 104, the gas/liquid separator 120, and the gas controller 140. The manifold 102 may include additional components and features, such as a pressure sensor or pressure gauge, for example.

The gas supply container 104 holds a predetermined gas material to be delivered to the gas delivery system 100. The gas supply container 104 comprises a container shell 106 and an outlet 107. The gas supply container 104 may comprise a pressure vessel and the gas material may be pressurized. The gas material may be pressurized at any desired pressure. The gas material may comprise a gas phase material, a liquid phase material, or both. Even where the gas supply container 104 holds mostly pressurized gas phase, some liquid phase material may appear in the released gas, especially where a large pressure drop accompanies the release of the gas.

In some embodiments, the gas material may comprise carbon dioxide, for example. Carbon dioxide is inexpensive, safe and easy to handle, and works well as a pressurized gas that can be used in various applications. However, when released from a pressurized container, a carbon dioxide material may include liquid carbon dioxide. For use in a powder delivery system, the liquid phase carbon dioxide is problematic and can cause a powder to clump together and/or cling to internal surfaces.

The gas/liquid separator 120 outputs only a gas phase of the material and liquid phase material does not pass through the gas/liquid separator 120. Gas that is released from the gas supply container 104 passes through the manifold 102 and into the gas/liquid separator 120. Liquid phase material from the gas supply container 104 may evaporate into gas phase material in the gas/liquid separator 120. The gas/liquid separator 120 provides the gas to the gas controller 140, such as through the manifold 102 in the embodiment shown.

The gas/liquid separator 120 includes a separator shell 121 forming an internal chamber 125, an input port 122, an output port 123, and a separator tube 126. The separator tube 126 includes a proximal end 131 and a distal end 132. The proximal end 131 comprises or is part of the output port 123.

The proximal end 131 of the separator tube 126 extends out from the separator shell 121 in some embodiments to form the output port 123. Alternatively, in other embodiments the proximal end 131 of the separator tube 126 ends substantially at an end of the separator shell 121 (i.e., at the end of the neck 128) to form the output port 123.

The separator tube 126 extends from the output port 123 into the interior of the separator shell 121, with the distal end 132 being located in a central region of the internal chamber 125. In some embodiments, the separator tube 126 ends at about the center of the internal chamber 125. The separator tube 126 does not extend to an opposite sidewall 121a of the separator shell 121. The open volume between the distal end 132 of the separator tube 126 and the opposite sidewall 121a provides space for liquid phase material to separate out from the gas phase material and settle to a bottom region of the separator shell 121. Gas phase material will occupy the region above the liquid phase material. The separator tube 126 can draw off the gas phase material without drawing out the liquid phase material.

The gas/liquid separator 120 is designed to be positioned substantially vertically, with the neck 128 being located substantially above the internal chamber 125. As a result, gravity will assist in the separation of the liquid phase material from the gas phase material. However, it should be understood that the gas/liquid separator 120 may be positioned in any orientation, as desired. For example, the gas/liquid separator 120 can be positioned substantially horizontally, wherein the distal end 132 of the separator tube 126 is spaced away from the sidewall of the separator shell 121.

In some embodiments, the proximal end 131 of the separator tube 126 extends out from the separator shell 121 to form the output port 123. Alternatively, the proximal end 131 may end substantially at the end of the separator shell 121.

The input port 122 comprises a space or clearance between the interior surface of the neck 128 and the separator tube 126. In some embodiments, the input port 122 comprises a substantially annular gap between the exterior of the separator tube 126 and the internal surface of a neck 128 of the separator shell 121. Alternatively, in some embodiments the separator tube 126 may be positioned against one side of the interior of the neck 128, leaving a crescent-shaped or non-regular space for flow of the gas material into the gas/liquid separator 120.

A spacer or spacers (or other structure) may be located between the separator tube 126 and the interior of the neck 128 to hold the separator tube 126 in position. Alternatively, the manifold 102 may position the separator tube 126 within the neck 128.

The configuration of the input port 122 may affect the flow of fluid into the gas/liquid separator 120. The configuration of the input port 122 may generate turbulent flow that aids in gas/liquid separation. The configuration of the input port 122 may generate a rotating, centrifugal flow that aids in gas/liquid separation.

The gas controller 140 is coupled to the manifold 102 and may be coupled to any manner of output conduit 143 that receives the dispensed gas. The gas controller 140 receives gas from the gas/liquid separator 120 and controls the dispensation of the gas. The gas controller 140 may control the release of the gas phase material. The gas controller 140 may control a flow rate of the dispensed gas. The gas controller 140 may control the pressure of the dispensed gas.

The gas controller 140 may include a valve or valves for controlling the release of gas. The gas controller 140 may include a pressure regulator that controls the pressure of the released gas. The gas controller 140 may include a flow meter or other measurement device that measures a mass flow rate or volume flow rate of the released gas.

In this embodiment, the gas controller 140 does not directly control the release of gas material from the gas supply container 104 and instead controls the release of gas material from the gas/liquid separator 120. However, when the gas controller 140 is not actuated, no gas material will pass from the gas supply container 104 to the gas/liquid separator 120. When the gas controller 140 is actuated and is open or at least partially open, gas material is permitted to flow from the gas/liquid separator 120. Therefore, gas material will be allowed to pass from the gas supply container 104 to the gas/liquid separator 120.

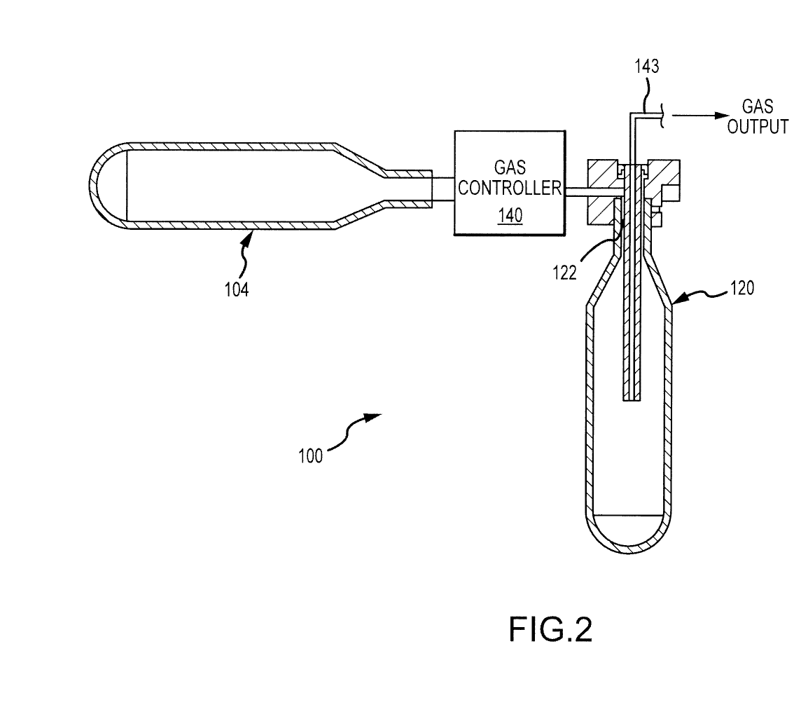

FIG. 2 shows the gas delivery system 100 according to another embodiment of the invention. The gas delivery system 100 in this embodiment is configured with the gas controller 140 being located between the gas supply container 104 and the gas/liquid separator 120. The gas controller 140 is therefore coupled to the input port 122 of the gas/liquid separator 120. The output port 123 of the gas/liquid separator 120 is coupled to the output conduit 143. The gas controller 140 therefore controls the release of the gas material from the gas supply container 104 to the gas/liquid separator 120. Gas material from the output port 123 of the gas/liquid separator 120 is not regulated. However, it should be understood that the outputted gas material flow stream may be regulated or controlled at any point downstream of the gas delivery system 100, as desired.

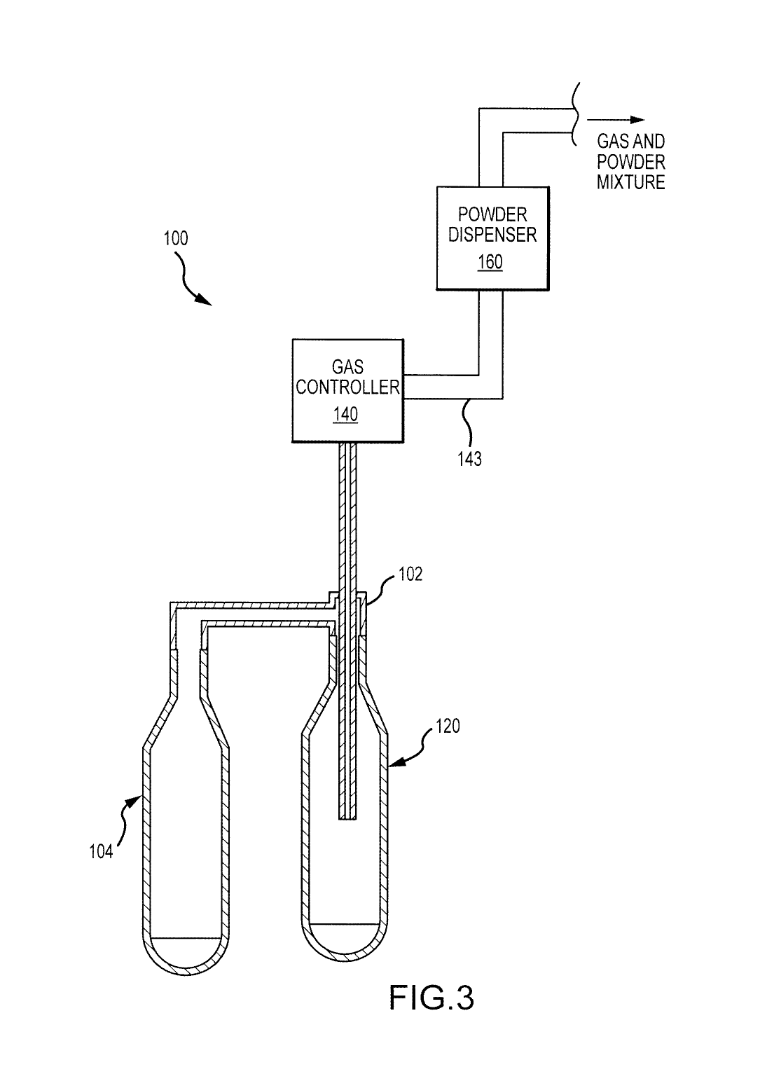

FIG. 3 shows a gas delivery system 100 configured to entrain and transport a powder according to an embodiment of the invention. For example, the gas delivery system 100 may be used to provide gas, such as carbon dioxide gas, to a powder dispenser 160. In the powder dispenser 160, the flow of gas is used to pick up, entrain, and deliver a flow of a powder including the gas. As is shown and discussed in FIGS. 1 and 2, the gas controller 140 can be located after the gas supply container 104 or can be located after the gas/liquid separator 120.

Carbon dioxide that is delivered from a pressurized container may include some liquid phase material. For use in a powder delivery system, the liquid phase carbon dioxide is problematic and can cause a powder to clump together and/or cling to internal surfaces. Advantageously, the gas/liquid separator 120 may be used to ensure that only gas phase carbon dioxide is provided to the powder dispenser 160.

We claim:

1. A powder delivery system having a gas/liquid separator (120), comprising:
a separator shell (121) forming an internal chamber (125);
a neck (128) formed in an end of the separator shell (121);
a separator tube (126) extending into the separator shell (121), with a proximal end (131) forming an output port (123) and with a distal end (132) extending into the internal chamber (125); and
an input port (122) formed between the separator tube (126) and the neck (128), wherein the distal end (132) of the separator tube (126) is located in a central interior region of the separator shell (121) and wherein liquid phase material accumulates in the internal chamber (125) and is not drawn out of the gas/liquid separator (120) by the separator tube (126);
a gas supply container (104);
a manifold (102) coupled to the gas supply container (104), wherein the gas/liquid separator (120) is coupled to the manifold (102), and wherein the gas/liquid separator (120) is configured to receive a gas material from the gas supply container (104), separate the gas material into a gas phase material and a liquid phase material within the internal chamber (125), and draw out the gas phase material via the separator tube (126), wherein the internal chamber (125) of the gas/liquid separator (120) is configured to retained the liquid phase material therein; and
a powder dispenser (160) configured to dispense a powder into the drawn out gas phase material.

2. (canceled)

3. The powder delivery system of claim 1, wherein the input port (122) comprises a shape and dimension to create a substantially turbulent flow into the gas/liquid separator (120).

4. The powder delivery system of claim 1, wherein the input port (122) comprises a shape and dimension to create a substantially rotating, centrifugal flow into the gas/liquid separator (120).

5. The powder delivery system of claim 1, wherein the proximal end (131) of the separator tube (126) extends out from the separator shell (121) to form the output port (123).

6. The powder delivery system of claim 1, wherein the proximal end (131) of the separator tube (126) ends substantially at an end of the separator shell (121) to form the output port (123).

7. (canceled)

8. The powder delivery system of claim 1, further comprising a gas controller (140) coupled to the gas/liquid separator (120), wherein the gas controller (140) is configured to regulate dispensation of gas phase material from the gas/liquid separator (120).

9. The powder delivery system of claim 1, further comprising a gas controller (140) coupled between the gas supply container (104) and the gas/liquid separator (120), wherein the gas controller (140) is configured to regulate dispensation of gas phase material from the gas/liquid separator (120).

10. A method of forming a powder delivery system, having a gas/liquid separator (120) the method comprising:
providing a separator shell (121) forming an internal chamber (125);
providing a neck (128) formed in an end of the separator shell (121);
providing a separator tube (126) extending into the separator shell (121), with a proximal end (131) forming an output port (123) and with a distal end (132) extending into an internal chamber (125) formed within the separator shell (121); and
providing an input port (122) formed between the separator tube (126) and the neck (128), wherein the distal end (132) of the separator tube (126) is located in a central interior region of the separator shell (121) and wherein liquid phase material accumulates in the internal chamber (125) and is not drawn out of the gas/liquid separator (120) by the separator tube (126), wherein:
the powder delivery system comprises:
a gas supply container (104);
a manifold (102) coupled to the gas supply container (104), wherein the gas/liquid separator (120) is coupled to the manifold (102), and wherein the gas/liquid separator (120) receives a gas material from the gas supply container (104), separates the gas material into a gas phase material and a liquid phase material within the internal chamber (125), and draws out the gas phase material via the separator tube (126), where in the liquid phase material is retained in the internal chamber (125) of the gas/liquid separator (120); and
a powder dispenser (160) that dispenses a powder into the drawn out gas phase material.

11. (canceled)

12. The method of claim 10, wherein the input port (122) creates a substantially turbulent flow into the gas/liquid separator (120).

13. The method of claim 10, wherein the input port (122) creates a substantially rotating, centrifugal flow into the gas/liquid separator (120).

14. The method of claim 10, wherein the proximal end (131) of the separator tube (126) extends out from the separator shell (121) to form the output port (123).

15. The method of claim 10, wherein the proximal end (131) of the separator tube (126) ends substantially at an end of the separator shell (121) to form the output port (123).

16. (canceled)

17. The method of claim 10, further comprising a gas controller (140) coupled to the gas/liquid separator (120), wherein the gas controller (140) is configured to regulate dispensation of gas phase material from the gas/liquid separator (120).

18. The method of claim 10, further comprising a gas controller (140) coupled between the gas supply container (104) and the gas/liquid separator (120), wherein the gas controller (140) is configured to regulate dispensation of gas phase material from the gas/liquid separator (120).
